(19) United States
(12) Patent Application Publication
(10) Pub. No.: US 2026/0191179 A1
(43) Pub. Date: Jul. 9, 2026

(54) DEVICES AND METHODS FOR SELECTIVE ERADICATION OF INSECTS USING MICROWAVE RADIATION

(71) Applicant: Zeteo Tech, Inc., Sykesville, MD (US)

(72) Inventors: Thomas McCreery, Sykesville, MD (US); Wayne A. Bryden, Sykesville, MD (US); Emily Caton, Reisterstown, MD (US); Alese Devin, Sykesville, MD (US); Maximilian Schrier Cetta, Potomac, MD (US); Dan Stewart, Sykesville, MD (US)

(73) Assignee: Zeteo Tech, Inc., Sykesville, MD (US)

(21) Appl. No.: 19/134,553

(22) PCT Filed: Nov. 21, 2023
(86) PCT No.: PCT/US2023/080768

§ 371 Date: May 30, 2025

Related U.S. Application Data
(60) Provisional application No. 63/428,806, filed on Nov. 30, 2022.

(51) Int. Cl. A01M 1/02; A01M 1/22

(52) U.S. Cl. CPC A01M 1/026; A01M 1/226

(57) ABSTRACT

Systems and methods to eradicate insects using microwave radiation at ±250 MHz of the resonance frequency of insects and without the use of chemicals. An insect eradication system includes one or more RF shielding layers supported on a collapsible frame and configured to form a canopy over infested objects including beds. A mobile cart disposed adjacent to the insect-infested object houses a microwave generator, power supply module, control module, and microwave transmission components. The incident microwave radiation frequency at ±250 MHz of the resonance frequency of the insects rapidly increases the temperature inside the carapace of the insect by flash heating and kills the insects while only minimally increasing the temperature of the insect-infected objects.

### RELATED APPLICATION

This Patent application claims priority to U.S. Provisional Patent Application No. 63/428,806 entitled “DEVICES AND METHODS FOR SELECTIVE ERADICATION OF INSECTS USING MICROWAVE RADIATION” and filed on Nov. 30, 2022, which is assigned to the assignee hereof. The disclosure of the prior application is considered part of this Patent Application and is incorporated by reference in this Patent application in its entirety.

### FEDERALLY SPONSORED RESEARCH AND DEVELOPMENT

None.

### TECHNICAL FIELD

This disclosure relates to systems and methods for selectively killing insects using microwave radiation while minimally impacting an insect-infested object by exposing the target insects to incident microwave radiation at frequencies similar to the resonant frequency of the target insects. More particularly, but not by way of limitation, this disclosure relates to methods and devices for selectively killing bed bugs.

### BACKGROUND

The common bed bug Cimex lectularius belongs to the Cimicidae insect family. Due to increasing global travel within the past decade, bed bug infestation is on the rise in the U.S. and around the world. Bed bugs can be inadvertently carried on furniture, couches, luggage, and other materials and bed bug infestation tends to be most severe in apartments, college dormitories, hotels, and motels. (Cranshaw et al., 2013). Bed bugs feed on human blood and cause itchy bites on human hosts. Bed bugs are a public health pest and multiply rapidly. These insects feed in the dark, usually in the middle of the night, and use exhaled carbon dioxide and body heat to locate their hosts (Miller and Polanco). A bed bug may probe the skin several times before it begins to feed resulting in several bites from the same bug. A bug may feed for about 5 min to 10 min every 3-7 days. A single female bug may produce about 120 to 200 eggs during a life span of about one year if it has regular access to blood meals. Egg mortality is low with a hatch rate of about 97%. At room temperatures of 70° F. to 90° F., eggs hatch in about 6 days to 10 days, and develop into adults in about 40 days after going through five developmental nymph stages. Each stage involves the shedding of the exoskeleton (also referred to herein as molting) and a blood meal is required by a nymph to molt successfully at each stage. Male and female adult bugs also require regular blood meals to reproduce. The size of a bed bug egg is about 1 mm. Nymphs are about 1.5 mm in size at stage 1 and about 4.5 mm at stage 5. (U.S. EPA). Adult bugs are about 5 mm to 7 mm in size. Bed bugs are usually concentrated near the vicinity of the bed. They are mostly found in clusters in bed frames, mattresses, lamps, nightstands and other furniture, behind pictures on the wall, and in other crevices next to the bed. When bed bug population becomes high, they may disperse more widely through the room. Insect migrations to adjacent rooms may occur through air ducts that interconnect between rooms, and holes in the walls provided for electrical wiring, electrical outlets, and plumbing.

Bed bugs may be controlled and eradicated using insecticides, but this treatment is not very effective because it requires insecticides to directly contact the insects. Bed bug eradication is difficult because all infested sites, for example, all rooms in an apartment complex, must be treated at the same time to prevent migration of these insects. Eggs are generally unaffected by insecticides, which therefore requires repeated application of the chemicals to ensure that insecticides are applied after the eggs are hatched. Insecticides used for bed bug control are primarily of the pyrethroid class of pesticides and include bifenthrin, lambda-cyhalothrin, deltamethrin, beta-cyfluthrin and chlorfenapyr (Cranshaw et al.). Deep injection of liquid insecticides into cracks and crevices may be achieved with sprayers equipped with a fine point nozzle. Aerosols containing pyrethrins or permethrin and sprays of non-persisting insecticides such as pyrethrins or tetramethrin will not be effective for bed bug eradication because at most only few insects that are directly contacted with sufficient quantity of the insecticide will be killed. Aerosols and sprays fail to adequately penetrate cracks and other crevices. Studies also suggest that bed bugs have developed resistance to some pesticides.

High temperature treatment is considered to be the primary non-chemical means of killing bed bugs (Cranshaw et al.). Specialized equipment used by professional pest control service providers may force high-temperature, dry steam heat into areas where bed bugs are present. This method is particularly useful for treating bed frames, box springs, and mattresses where insecticides are not effective. Temperatures at the surface of treated areas must reach about 140° F. to 150° F. to kill bed bugs hiding in adjacent crevices. Steam treatment is time consuming and may take 15 seconds or more to treat about 1 sq. ft. Condensed water or excessive humidity in the treated room may lead to mold formation and cause damage to books, pictures, clothes, and the like in the room. Dry heat treatments may also damage books and other furniture in the room.

U.S. Pat. No. 8,943,744 titled “APPARATUS FOR USING MICROWAVE ENERGY FOR INSECT AND PEST CONTROL AND METHODS THEREOF,” discloses an apparatus and methods for using microwave energy for treating sites infested with insects such as bed bugs or other small pests. The apparatus includes a source of microwave energy connected to a power source and a power controller, a transmission element, and an antenna. The apparatus can also include an isolator to protect the source of microwave energy. The disclosure provides that the microwave energy is absorbed by the insects, their eggs or larvae, or small pests, which raises their internal temperature up to the point of death, with little or no impact on surrounding fabrics or mattress materials and wood. A typical household microwave magnetron that operates between 2.35 GHz and 2.65 GHz can be used as the source of microwave energy. The disclosed method for controlling insects includes forming a beam of microwave energy, directing the beam towards an infected site, scanning the infected site, determining if treatment has been effective and repeating the scanning step. No details on exposure time are provided. It is well known that treating an infected area as disclosed will increase the temperature of the materials such as furniture, books, clothes and bedding exposed to incident radiation, just as heating food materials in a household microwave oven, and cause deterioration in their value or negatively impact their fit for a particular purpose.

Tyrpak (2016) studied the effect of microwave energy on bed bug eggs, nymphs and adults by placing eggs, nymphs, and adults on various substrates inside a 700 W, 2.45 GHz microwave oven. In the case of eggs, bed bug eggs were supported on filter paper, placed in a small petri dish and treated in the microwave oven at treatment times of 5 s to 35 s. The eggs were then observed over a period of two weeks. Results suggested that treatment times of at least 25 s was required to destroy the eggs and prevent them from hatching. Nymphs and adults, including fed male and female adults, were placed in a 250 ml beaker and then treated in the oven for up to 30 s. The bugs were then monitored for at least 24 h. Results suggested that the effective treatment time for adults and stage-4 and stage-5 nymphs was about 26 s and that for stage-1 nymphs was about 44 s. Only about 10% of the recently fed bugs “burst” upon exposure to microwave energy. In another test, nymphs and adults were placed inside books and then treated in the microwave oven at 30 s, 60 s and 90 s treatment times. Here, the effective treatment time for nymphs and adults ranged from 60 s to 90 s. Books were found to be damaged after 90 s treatment because melted binding, crinkly pages, and burn marks were observed. When placed in the oven for about 2 min, the books continued to radiate heat when taken out.

Rapid chemical-free systems and methods of eradicating bed bugs and other insects are needed. Conventional methods of eradication use dry heat or pesticides. These conventional methods are not desirable for hotel or cruise ship applications as they produce a chemical smell that alerts guests to an insect contamination problem. Further, it has been shown that in military operations bed bug infestation has a major impact on morale. Military berthing in both terrestrial and maritime operations have similar challenges. Bed bugs do not carry disease, but they have large economic impacts.

Although the use of microwave energy for bed bug treatment has been previously reported, the reported methods and devices result in increasing the temperature of materials and objects infested with these insects and partially or completely destroys these materials. A need exists for devices and methods that uses microwave energy to selectively destroy bed bugs and other insects such as termites without causing any damage to the infested materials such as mattresses, walls and furniture and at low “per treatment” costs.

### SUMMARY

In some implementations, an insect eradication system may include a collapsible canopy frame configured to be disposed over an insect-infested object, one or more RF shielding curtains supportable by the canopy frame and configured to envelop the insect-infested object, one or more microwave horn antennas supported by a plurality of roof support members on the canopy frame, wherein the horn antennas are disposed at a predetermined distance above the insect-infested object, and a portable cart movably disposed outside the RF shielding envelop and including a microwave generator and a control system. In some implementations, the control system may be configured to implement one or more of operate the microwave generator to generate microwave radiation at a frequency that is within +250 MHz of a resonance frequency of the insect, transmit microwave radiation from the microwave generator to the one or more horn antennas, or direct the microwave radiation towards the insect-infested object.

In some implementations, the one or more RF shielding curtains may include a first curtain configured to envelop the insect-infested object and a second curtain disposed external to the first curtain. In some implementations, the one or more horn antennas each may include a flared end wherein the predetermined distance between the infested object and the flared end of the horn antennas may be about 2 ft. In some implementations, the one or more horn antennas may include pyramidal horn antennas. In some implementations, the one or more horn antennas may be configured to be connected to one or more swivel couplings supported by the plurality of roof support members.

In some implementations, the portable cart may include a plurality of internal compartments wherein at least one of the internal compartments may be configured to store one or more of the one or more horn antennas or the one or more RF shielding curtains. In some implementations, the portable cart may include a control system configured to communicate with an application software on a smart device to remotely move the portable cart. In some implementations, the portable cart may include a rechargeable battery power system.

In some implementations, an example method for selectively eradicating insects in an insect-infested object may use microwave radiation while minimally impacting a host object for the insects. In some implementations, an example method may begin with providing a decontamination system to envelop the insect-infested object. In some implementations, the system may include one or more RF shielding curtains configured to envelop the infested object, wherein the one or more RF shielding curtains may be supportable by a collapsible canopy frame. In some implementations, an example decontamination system may include a portable cart including a microwave generator, which may be movably disposed outside the RF shielding curtains. In some implementations, an example decontamination system may be configured to transmit microwave radiation from the microwave generator toward the insect-infested object.

In some implementations, an example method for selectively eradicating insects in an insect-infested object may continue with selecting a first incident microwave radiation frequency, which may be within +250 MHz of a resonance frequency of the target insect and exposing the insect-infected object to microwave radiation for a first predetermined first treatment time. In some implementations, the first incident microwave radiation frequency may be between about 10 GHZ and about 15 GHz. In some implementations, the first incident microwave radiation frequency may be about 12.5 GHz. In some implementations, the first predetermined treatment time may be between about 5 s and 30 s. In some implementations, the example method for selectively eradicating insects in an insect-infested object may further include the step of examining the infested object after the first treatment time and repeating the decontamination method if insect eradication is less than about 99%.

In some implementations, the repeating step may include exposing the infested object to microwave radiation at a second frequency that is greater than the first frequency. In some implementations, the repeating step may include exposing the insect-infested object to microwave radiation for a second treatment time that is greater than the first predetermined treatment time. In some implementations, the examining step may include examining the insect-infested object using one or more of visual inspection or inspection using a thermal imaging camera, or a combination of both.

In some implementations, an insect eradication system may include a collapsible canopy frame configured to be inflated to form an inflated canopy frame over an insect-infested object, a prefabricated microwave shield (RF shield) configured to envelop the inflated canopy frame, and one or more microwave horn antennas supported by a plurality of roof support members on the canopy frame. In some implementations, the one or more horn antennas may be disposed at a predetermined distance above the infested object. In some implementations, an example insect eradication system may include a portable cart movably disposed outside the prefabricated microwave shield. In some implementations, the portable cart may include an air pump to inflate the collapsible canopy frame and a microwave generator. In some implementations, an example insect eradication system may include a control system configured to implement one or more of operate the microwave generator to generate microwave radiation at a frequency that is within ±250 MHz of a resonance frequency of the insect, transmit microwave radiation from the microwave generator to the one or more horn antennas or direct the microwave radiation towards the insect-infested object.

In some implementations, microwave radiation may be characterized by a frequency of between about 10 GHz and about 15 GHz. In some implementations, microwave radiation may be characterized by a frequency of about 12.5 GHz. In some implementations, the one or more horn antennas may include pyramidal horn antennas. In some implementations, the one or more horn antennas may be configured to be connected to one or more swivel couplings supported by the plurality of roof support members.

Other features and advantages of the present disclosure will be set forth, in part, in the descriptions which follow and the accompanying drawings, wherein the preferred aspects of the present disclosure are described and shown, and in part, will become apparent to those skilled in the art upon examination of the following detailed description taken in conjunction with the accompanying drawings or may be learned by practice of the present disclosure. The advantages of the present disclosure may be realized and attained by means of the instrumentalities and combinations particularly pointed out in the appendant claims.

### BRIEF DESCRIPTION OF THE DRAWINGS

The foregoing aspects and many of the attendant advantages of this disclosure will become more readily appreciated as the same becomes better understood by reference to the following detailed description, when taken in conjunction with the accompanying drawings, wherein:

FIGS. 1A-1H show schematic diagrams of various components of an example insect eradication system, according to some implementations: (A) perspective view of a collapsible canopy configured to envelop the infested object (bed) to be treated, (B) perspective view of the collapsible canopy in a collapsed state, (C) perspective view of the canopy with internal and external microwave shielding, (D) side view of the canopy with the internal shielding rolled-up, (E) another perspective view of the canopy showing the external microwave shielding with internal shielding rolled-up, (F) perspective view of the fully assembled canopy with mobile cart housing the microwave generator, (G) perspective view of an example insect eradication system for disinfecting beds in a dormitory, and (H) another perspective view of an insect eradication system for disinfecting beds in a dormitory type room.

FIGS. 2A-2C show perspective views of an example mobile cart housing the microwave generator in an insect eradication system, according to some implementations: (A) perspective view of the cart with compartment panels closed, (B) perspective view showing a compartment for storing microwave shield curtains and horn antennas, (C) perspective view showing a compartment for housing the microwave generator and ancillary components.

FIGS. 3A-3D show perspective views of various components of an example insect eradication system, according to some implementations: (A) perspective view of an inflatable frame configured to support microwave horn antennas over a infested bunk in a bunk bed, (B) perspective view showing the inflatable frame disposed in a bunk with a mobile cart housing a microwave generator adjacent to the bunk bed, (C) perspective view of a prefabricated microwave (RF) shield member, and (D) perspective view of the RF shield disposed over the inflatable frame to envelop the infested bunk.

FIG. 4 shows a schematic diagram of an example insect eradication method using microwave radiation, according to some implementations.

FIG. 5A-5C show example simulation results of power deposition maps inside bed bugs at various microwave incident frequencies, according to some implementations.

All reference numerals, designators and callouts in the figures are hereby incorporated by this reference as if fully set forth herein. The failure to number an element in a figure is not intended to waive any rights. Unnumbered references may also be identified by alpha characters in the figures and appendices. In general, like reference numbers and designations in the various drawings indicate like elements.

The following detailed description includes references to the accompanying drawings, which form a part of the detailed description. The drawings show, by way of illustration, specific embodiments in which the disclosed systems and methods may be practiced. These embodiments, which are to be understood as “examples” or “options,” are described in enough detail to enable those skilled in the art to practice the present invention. The embodiments may be combined, other embodiments may be utilized, or structural or logical changes may be made, without departing from the scope of the invention. The following detailed description is, therefore, not to be taken in a limiting sense and the scope of the invention is defined by the appended claims and their legal equivalents.

The terms “a” or “an” are used to include one or more than one, and the term “or” is used to refer to a nonexclusive “or” unless otherwise indicated. In addition, it is to be understood that the phraseology or terminology employed herein, and not otherwise defined, is for the purpose of description only and not of limitation. Unless otherwise specified in this disclosure, for construing the scope of the term “about,” the error bounds associated with the values (dimensions, operating conditions etc.) disclosed is ±10% of the values indicated in this disclosure. The error bounds associated with the values disclosed as percentages is ±1% of the percentages indicated. The word “substantially” used before a specific word includes the meanings “considerable in extent to that which is specified,” and “largely but not wholly that which is specified.” “Autonomous” means “with no or minimal intervention by a professional technician or instrument operator.”

### DETAILED DESCRIPTION

Particular aspects of the invention are described below in considerable detail for the purpose of illustrating the compositions and principles, and operations of the disclosed methods and systems. However, various modifications may be made, and the scope of the invention is not limited to the example aspects described.

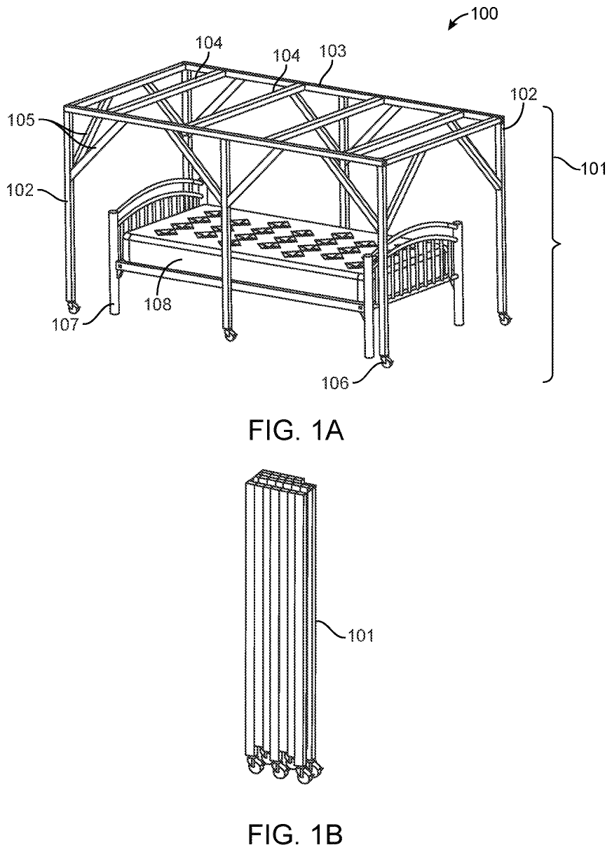

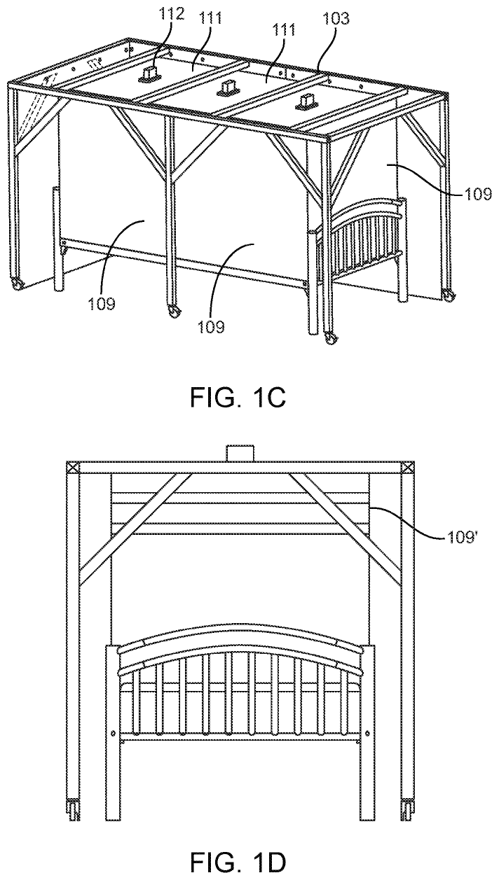

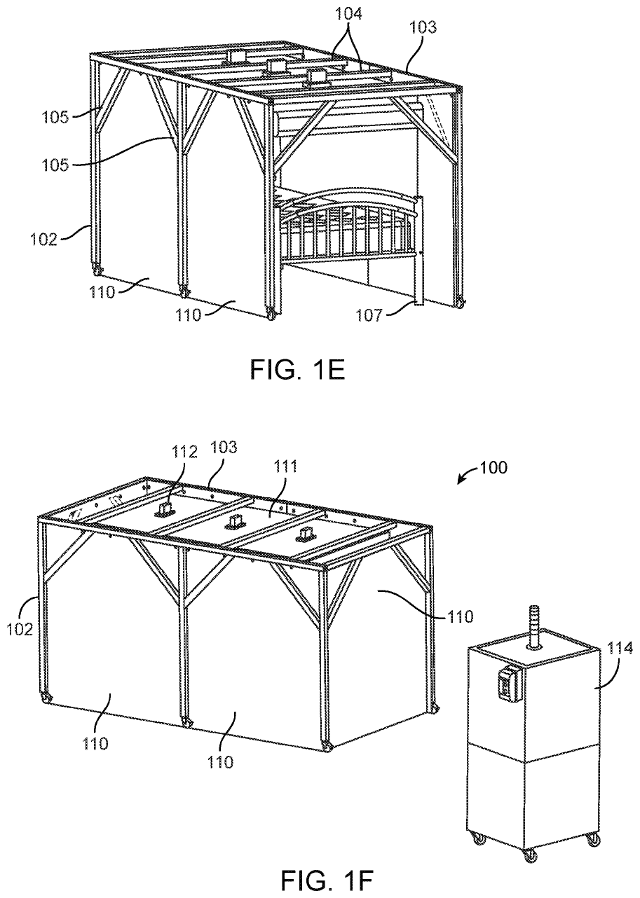

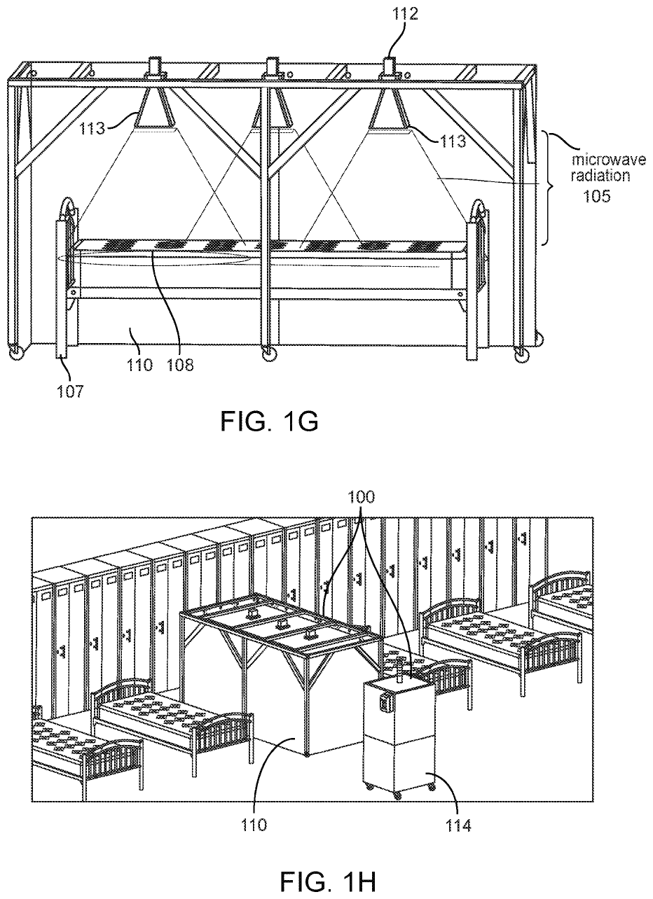

FIGS. 1A-1H show schematic diagrams of an example insect eradication system 100, according to some implementations. Example insect eradication systems may be configured for disinfecting bedding, gear, and other articles in hospitals, college dormitories, hotels, hostels, motels, military berthing, military tentage, and the like. Example system 100 may be configured to treat articles and areas infested with insects such as bed bugs by exposing the infested articles, objects, and areas to microwave radiation. Example system 100 may include a collapsible canopy frame 101 that may be sized to cover or envelop, for example, standard twin beds or standard twin XL beds, or beds of other sizes 107. Bed 107 may include a mattress 108 that may be infested with insects such as bed bugs. For example, the external dimensions of example canopy frame 101 may be about 96 in. (L)×about 48 in. (W) and about 52 in. (H). Canopy frame 101 may include a plurality of legs or posts 102 to support collapsible top frame 103. Top frame 103 may include a plurality of collapsible horizontal roof support members 104 that run across the width of frame 103. Top frame 103 may also be attached to legs 102 using a plurality of collapsible strut members 105. Each of the plurality of legs 102 may be configured to be connected to a caster 106 to enable the canopy frame 101 to be maneuvered around a bed to be disinfected or inside a room that houses a plurality of beds as can be seen in FIG. 1H. Canopy frame 101 is therefore configured to enable insect eradication system 100 to be easily stored and easily transportable, with minimal set-up time to assemble and commission for insect eradication. In its collapsed form, canopy frame 101, as shown in FIG. 1B, may be easily transported and stored in tight spaces. Example collapsed canopy frame 101 may be characterized by dimensions 11 in. (L)×6 in. (W)×52 in. (H).

Canopy frame 101 may be configured to support one of more radio frequency (RF) shielding panels or curtains 109 (as shown in FIG. 1C) to isolate articles or objects or areas infested with insects during microwave radiation treatment. Shielding panel or curtain 109 may include a single panel or curtain supported by top frame 103 and horizontal roof support members 104. Panel or curtain 109 may be configured as a plurality of curtains or sections. Curtain 109 may be configured to envelop the area or article such as the bed shown in FIG. 1C during treatment using microwave radiation. Example curtain 109 may include single layer curtains or multilayer curtains, for example, as sold by Akon Curtains (Fernandina Beach, FL), and may be RoHS compliant. RoHS refers to The Restriction of Hazardous Substances Directive 2002/95/EC (European Union standard) and relates to restrictions on the use of certain hazardous substances in electrical and electronic equipment.

In some implementations, example curtain 109 may be used to shield microwave radiation of frequency between about 400 MHz and about 18 GHz. Example curtain 109 may include nylon material coated with acrylic 40 and plated or woven with one or more of layers including silver, copper or nickel. Example curtain 109 may also include an electrostatic discharge protective layer to reduce static charge buildup that could damage electronic equipment. Example curtain 109 may also attenuate sound or noise by between about 80 dB to about 85 dB at between about 30 MHz to 11 GHz. Example curtain 109 may also be flame resistant and compliant with NFPA 701 standard. Example curtain 109 may include a plurality of grommets (not shown) to removably attach to roof support members 104 of canopy frame 101 using suitable hooks. Canopy frame 101 may be configured to provide a curtain track with glide roller hooks to roll the curtain 109 around the article or area to be treated such as the mattress 108 or bed 107. Curtain 109 may be removably attached using magnets or hook-and-loop fasteners such as Velcro® to roof support members 104. Curtain 109 may also be rolled up (109′) as shown in FIG. 1D to facilitate moving canopy frame 101 after insect eradication is completed.

Example insect eradication system may also include a secondary shielding curtain or panel 110 (as shown in FIG. 1E) disposed external to RF shielding curtain or panel 109. Example external shielding panel 110 may be made of a material that has similar properties to that of panel 109 and may be configured to be removably connected to top frame 103. External shielding panel 110 may be configured as a plurality of shielding panels, each disposed to be supported by adjacent legs 102 and top frame 103. For example, a plurality of shielding panels 110 may be configured to be slidably and removable disposed in grooves or guiding tracks that extend along the length of each leg 102. When example insect eradication system 100 is assembled as described above, the system is configured to envelop an object to be treated such as mattress 108 using one or more microwave shielding layers and is therefore isolated from personnel and objects in the surrounding areas. The one or more external shielding panels 110 shield personnel, equipment and objects outside assembled system 100 from stray or reflected microwave and other radiation.

In some implementations, example system 100 may include one or more top panels 111 disposed between two adjacent horizonal support roof members 104 and configured to be disposed above the object to be treated using shield 109 (as can be seen in FIGS. 1C, 1F). Top panels 111 may also include one or more layers or coatings of microwave shielding materials on the surface facing the object to be treated. The one or more top panels 111 and roof members 104 may be configured to removably support one or more microwave horn antennas 113 (as can be seen in FIG. 1G) such that the horn antennas are disposed above the object or mattress to be treated. Example horn antennas may include 10 GHz to 15 GHz WR75 standard gain horn antennas (Pasternack, Irvine, CA). The distance between the flared end of the horn antennas (the microwave radiation exit end disposed opposite to the waveguide) and the surface of the mattress may be about 2 ft. Each horn antenna 113 may be configured as a pyramidal horn antenna. Each horn antenna 113 may include other types of horn antenna's that include, but are not limited to, conical horns or corrugated horns. Each horn antenna 113 may be configured to direct microwave radiation 115 from waveguide 112 connected to microwave generator towards the object to be treated inside canopy frame 101 (as can be seen in FIG. 1G). In an example aspect, each horn antenna 113 may be connected using suitable swivel connectors or couplings or joints to the roof member supports 104 and are configured to movable in one or more directions (X-Y-Z) to sweep the object to be treated with microwave radiation. The microwave generator may be disposed in cart 114 (FIG. 1F). Cart 114 may also include a battery power system using one or more rechargeable batteries, a battery management system, and battery recharge management system. Cart 114 may be movably disposed near and outside the canopy frame 101 during treatment of an object.

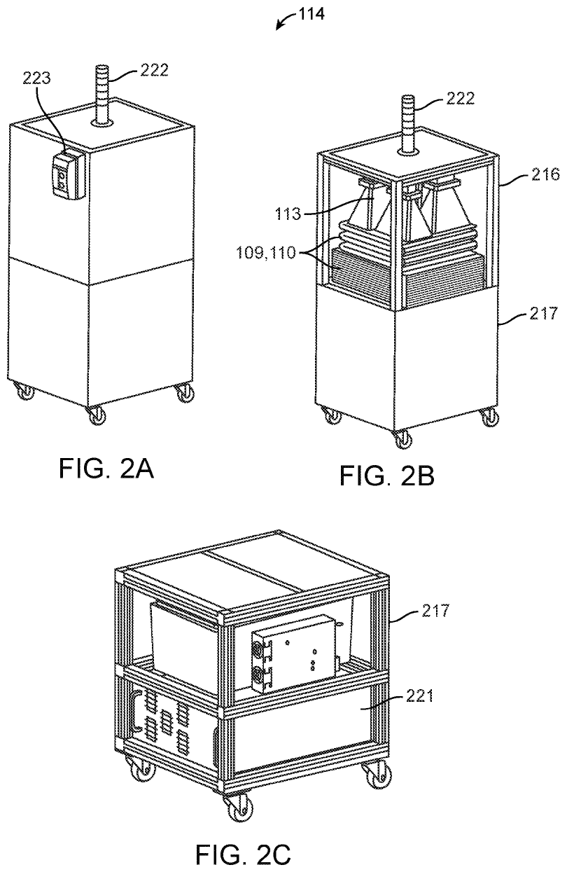

FIGS. 2A-2C show schematic drawings of an example cart 114 associated with a system for decontaminating insect-infested objects, according to some implementations. Example cart 114 (as can be seen in FIGS. 2A-2C) may include a plurality of internal compartments 216 and 217 accessible using removable panels or doors. Compartment 206 may be configured as a storage compartment to store one or more of the shielding curtains 109, 110 and horn antennas 113. Compartment 217 may be configured to house including, but not limited, microwave generator 221, a power supply module, and the rechargeable battery power system. Microwave generator may include components that include, but are not limited to, a magnetron, power converter, a master microcontroller or control system, and microwave radiation transmission elements including coaxial cables (not shown for simplicity) configured to couple or removably connect to each wave guide 112 for guiding microwave radiation from the coaxial cables to radiate out from horn antennas 113 toward the infested object disposed within canopy frame 101. Commercially available magnetrons such as resonant cavity magnetrons rated at 500 W to 2 kW may be used. Microwave radiation may be characterized by a frequency of between about 5 GHz and about 20 GHz. Microwave radiation may be characterized by a frequency of between about 10 GHz and about 20 GHz. Microwave radiation may be characterized by a frequency of between about 12 GHz and about 15 GHz.

In some implementations, the master control system housed in compartment 217 may be configured to implement insect eradication protocols and tune parameters including one or more of frequency of microwave radiation, frequency band of microwave radiation, power density (W/cm² or mW/cm²), or microwave radiation exposure time. The master control system may be configured to expose the infested object to microwave radiation for a predetermined treatment (eradication) time period. The master control system may be configured to repeat microwave generation for decontamination during a second eradication time period, and subsequent treatment periods. The master control system may be configured to control and implement any desired microwave treatment protocols. Example cart 114 may include light indicator 222 that may be easily visible to operators and other personnel to indicate that eradication system is in operation. Example cart 114 may include electrical ON/OFF switch 223. Example cart 114 may be characterized by dimensions 21 in. (L)×24 in. (W)×50 in. (H). Example compartment 217 may be characterized by dimensions 21 in. (L)×24 in. (W)×26 in. (H).

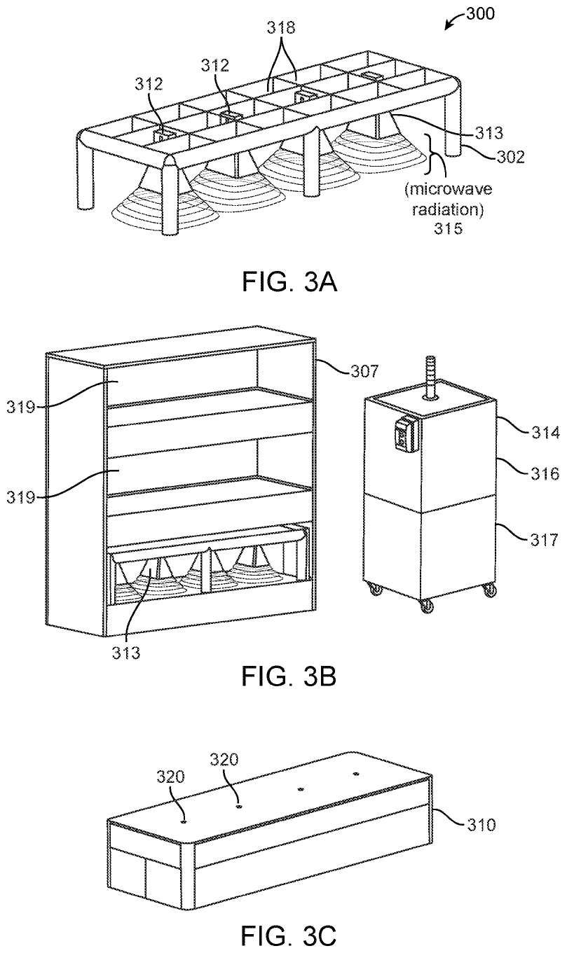

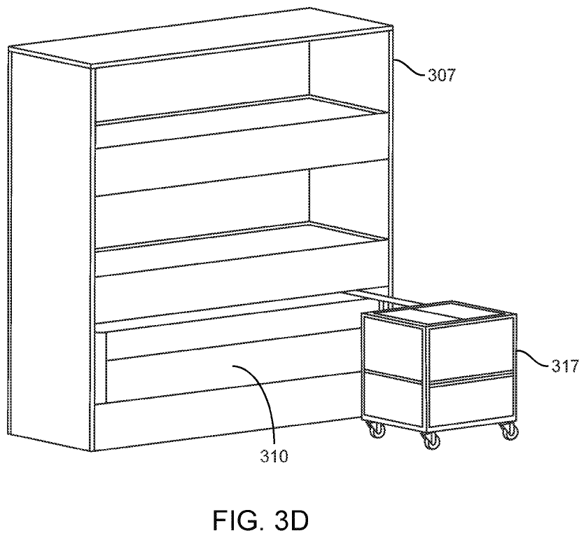

FIGS. 3A-3D show schematic diagrams of another example insect eradication system 300 configured to treat bunk beds and other objects in tight spaces using microwave radiation, according to some implementations. Example system 300 may include inflatable frame 302, which may be configured and sized to fit in the space above each bunk 319 in bunk bed 307 (as can be seen in FIG. 3B) when inflated. Frame 302 may be inflated after positioning frame 302 within bunk 319 in bunk bed 307. An air pump may be disposed in compartment 317 of cart 314 and may be used to provide air to inflate frame 302. Frame 302 may include cross members 318 configured to support one or more wave guides 312 of one or more microwave horn antennas 313. When disposed in frame 302, the one or more horn antennas are disposed above the surface of the mattress in bunk 319 (as can be seen in FIG. 3B). Microwave shield 310 (as can be seen in FIG. 3C) may then be configured to envelop inflated frame 302 disposed in bunk 319. (FIG. 3D).

Alternately, in some implementations microwave shield curtains 109, 110 may be used to isolate the bunk to be treated. The one or more horn antennas 313 are configured to direct microwaves towards the mattress in bunk 319 to enable the entire surface of the bed to be treated with microwave radiation 315 for a predetermined time or following a predetermined treatment protocol. The microwave generator may be disposed in compartment 317 of cart 314. Microwave radiation from the microwave generator may be transmitted to the one or more waveguides 312 using coaxial cables and through openings 320 provided in shielding 310. Each horn antenna 313 may be configured to move in one or more directions to sweep the infested object (mattress in bunk bed) with microwave radiation. Compartment 317 may be configured to house including, but not limited, microwave generator, a power supply module, and a rechargeable battery bank. Microwave generator may include components that include, but are not limited to, a magnetron, power converter, a master microcontroller or control system, and microwave radiation transmission elements including coaxial cables (not shown) connected to each wave guide 312 for guiding microwave radiation from the coaxial cables to radiate out from horn antennas 313 toward the object that needs to be treated and disposed inside shield 310.

In another example aspect of insect eradication system 100, cart 114 may be configured to be remotely operated by a human operator, for example using an application software or “app” installed on a smart device. The “app” may also be configured to operate the insect eradication system by implementing predetermined insect eradication protocols including one or more of the microwave radiation frequency, microwave radiation exposure time, or examine the effectiveness of treatment. In another example aspect of system 100, cart 114 may be configured to move substantially autonomously as a robotic cart; that is, it may be capable of sensing its environment and moving with minimal human input. The motors and drive train of the robotic cart may be controlled using the master control system or may be controlled using a dedicated control system which may be configured to take instructions from and communicate with the master control system. Robotic cart 114 may use a plurality of sensors for sensing its surroundings and for navigation, that include, but are not limited to, radar, computer vision, GPS, ultrasonic proximity sensors, optical sensors, sonar and gyroscopes. A robotic mobility subsystem may include an undercarriage including wheels or castors. Another example cart 114 may include a graphical user interface for manually selecting or inputting treatment parameters that include, but are not limited to, start, stop, and treatment protocol that include, but are not limited to, exposure time, wait time and cycling of treatments until the infested surface is treated to result in substantial insect eradication.

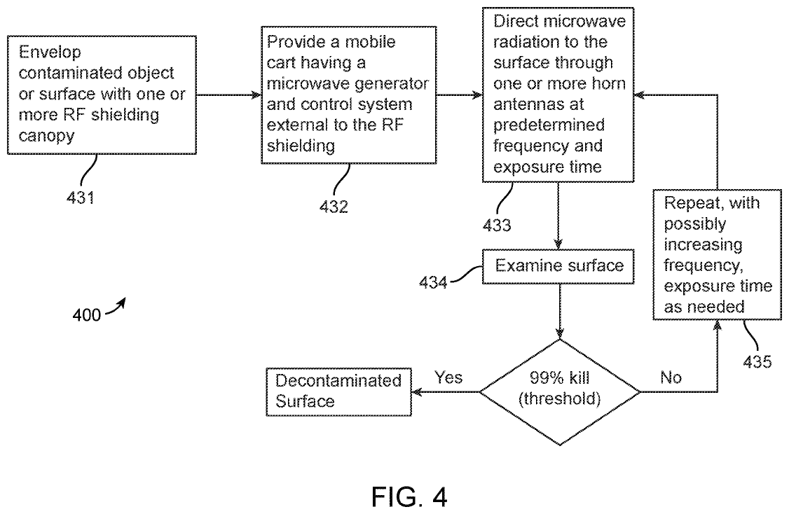

FIG. 4 shows a schematic diagram of an example insect eradication method 400 for selectively eradicating insects using microwave radiation while minimally impacting host media such as bedding and furniture, according to some implementations. The target insects may include one or more of bed bugs, termites, bat bugs, swallow bugs, poultry bugs, ticks, or rice weevils. Example operation 400 may begin at 431 with providing a suitable RF shielding canopy to envelop the infested object or surface. For example, example double-layer shielding 109 and 110 may be used to provide the canopy. Alternately, RF shielding may be provided by prefabricated canopy 310 sized to treat bunk beds or infested objects. At 432, example operation 400 may include providing a mobile cart including a microwave generator and components for transmitting microwave radiation from the microwave generator and directing microwave radiation to the infect-infested surface.

Example mobile cart may include cart 114 as previously described, which may be configured to be located near the RF shielding canopy at 432 during insect eradication. The insect-infested surface or object may then be exposed to microwave radiation at a predetermined frequency for a predetermined exposure time at 433. Depending on the type of insect that needs to be eradicated, the frequency of incident radiation may be selected to be between about 2 GHz and about 20 GHz. In some implementations, the frequency of incident microwave radiation may be between about 5 GHz and about 15 GHz. In some other implementations, the frequency of incident microwave radiation may be between about 10 GHz and about 15 GHz. In some implementations, the frequency of incident microwave radiation for insect eradication may be about 12.5 GHz. The object to be treated may be exposed to microwave radiation over a treatment time of between about 5 s and 60 s. The microwave radiation treatment time may be between about 5 s and about 30 s.

Alternately, the objects to be treated may be exposed to microwave radiation in pulses. The infested surface may then be examined in step 434 to determine whether insect eradication was effective. An example microwave insect eradication method disclosed herein may be considered to be effective if at least 99% (threshold level) of the target insects of all life stages including eggs are eradicated or killed. The step of examining the infested surface after exposure to microwave radiation may include visual inspection. Alternately, a thermal imaging camera configured to detect insects may be used. An example of suitable thermal imaging cameras may be Exx-Series cameras sold by Teledyne FLIR (Wilsonville, OR). The examination step may be performed substantially continuously during the insect eradication process or at predetermined intervals. If the examination step 434 reveals that insect eradication is less than effective, the microwave insect eradication process may be repeated in step 435. The repeating treatment step may include increasing one or more of the incident microwave radiation frequency or exposure time.

The example insect eradication method may include a hold time between repetitions of eradication protocols. Example insect eradication treatment method 400 may further include tuning the incident frequency, pulse width and pulse interval of microwave radiation (if microwave pulses are used) taking into account the dielectric properties and bulk conductivity of the target insects. The selected incident microwave radiation frequency may be within +250 MHz of the resonance frequency of the target insects. The target insects may have more than one resonance frequency depending on the water content inside the body and whether insects have recently had a blood meal. Subsequently, the frequency of microwave radiation is selected to cover a resonance frequency range of the target insects. Exposing target insects to microwave radiation at a frequency of +250 MHz of the resonance frequency of the insects may cause the insects to oscillate at resonance frequency and at a higher amplitude than at other frequencies. The temperature inside the insect is rapidly increased (flash heating) but is localized inside the carapace of the insect. As such, the insects are killed while only minimally increasing the temperature of the surrounding media. Each insect may have a characteristic resonance frequency.

External materials or media that include one or more of beds, books, sofas, or walls that may be infested with insects are not damaged by the exposure to microwave radiation using the example methods disclosed. Example infested objects may also include one or more of mattresses, luggage furniture, crevices in the walls, or carpets. During exposure to microwave radiation as disclosed above at a frequency of +250 MHz of the resonance frequency of the insects, the temperature of these objects is not increased substantially above ambient temperature during the short duration time periods. For example, the increase in temperature in the medium during exposure to microwave radiation may be less than about 10% of ambient temperature.

Without being bound by any particular theory, insects are poor electrical conductors and may be considered to be dielectric materials having a dielectric constant ϵ′ and dielectric loss factor ϵ″. In the example methods described above, the insects may selectively respond as oscillators to incident microwave radiation without adversely affecting the host medium on account of the differences in the dielectric properties between the insects and the host media. In microwave applications, the power dissipated per unit volume, P, is absorbed by a material (for example, insects) from an alternating electrical field as:

$$P = {E}^{2} σ = {kfE}^{2} {ε}^{″} \qquad ( 1 )$$

where, E is the electrical field intensity in the material, k is a constant that depends on the units used for calculating P, f is the frequency of microwave radiation in Hz, and ϵ″ is the dielectric loss factor of the insect and includes the energy losses in the dielectric body (material) of the insect due to all operating dielectric relaxation mechanisms and ionic conduction (Nelson, 2001). Dielectric properties of various insects were calculated by Ondráček and Brunnhofer (1984) based on shift of resonance frequency in a resonator both before and after the insertion of the sample into a resonator at 2.375 GHz. The publication by Ondráček and Brunnhofer titled “DIELECTRIC PROPERTIES OF INSECT TISSUES” is incorporated by reference herein in its entirety. Further, the publication by Nelson (2001) titled “RADIO FREQUENCY AND MICROWAVE DIELECTRIC PROPERTIES OF INSECTS” is incorporated by reference herein in its entirety. The dielectric properties of insects depend on the chemical and physical composition of the insects that include but are not limited to the size of the insects, water content, the chemical binding nature of water, the frequency of the applied electrical field, bulk electrical conductivity, bulk electrical thermal conductivity, and the temperature of the material. The dielectric constant of insects may remain constant or may decrease with increasing frequency. The dielectric loss factor may increase or decrease with increasing frequency.

Without being bound by any particular theory, the dielectric function ε(f) of a material, where ε is the relative permittivity of the material, and f is the frequency of radiation, is generally related to incident radiation frequency, the resonance frequency of the material, and the plasma frequency, if applicable, through a dispersion model. In a wider spectral range (above low frequency) where more than one energy transition level may be present, the dielectric function may include different transitions, each characterized by a resonance frequency. The characteristic property of an oscillating system is the phenomena of resonance at a specific frequency. Once the resonance frequency of a material such as a target insect is known or calculated using suitable methods, application of an external force (e.g., microwave radiation) at the same resonance frequency will make the material oscillate at a higher amplitude compared to when microwave radiation is applied at other frequencies.

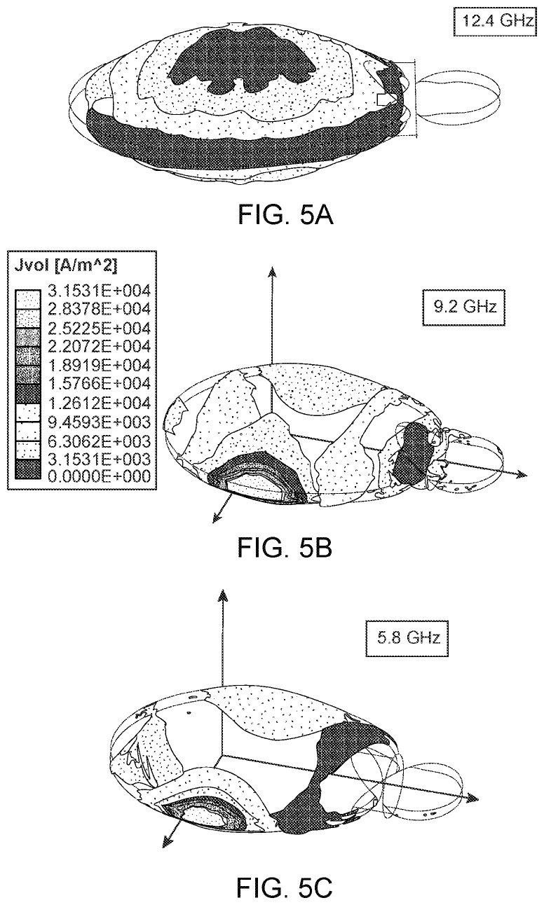

FIGS. 5A-5C shows the results of finite element analysis of power deposition as evidenced by the distribution of complex magnitude volume current in A/m² (Jvol) within adult bed bugs when exposed to microwaves of three different frequencies. As can be seen in FIGS. 5B-C, exposure to microwave radiation at 5.8 GHz and 9.2 GHz resulted in localized and non-uniform distribution of volume current and in the creation of a hot spot region within the body of the bug with some areas of the bug not impacted by incident radiation. The hot spot region may be caused by localized vibration of molecules in that region caused by the exposure to incident microwave radiation. However, as can be seen in FIG. 5A, at a frequency of 12.4 GHz, the incident radiation is distributed throughout the entire insect body without any localized concentration or hot spots. That is, the insect body appears to be vibrating at its resonance frequency. A similar simulation study using termites of nominal dimensions 10 mm (L)×4 mm (W)×2.5 mm (H) suggests that microwave radiation at a frequency of between about 13 GHz and about 15 GHz may be required to eradicate termites. The publication by Thielens (2018) titled “EXPOSURE OF INSECTS TO RADIO-FREQUENCY ELECTROMAGNETIC FIELDS FROM 2 TO 120 GHZ” is incorporated by reference herein in its entirety.

As discussed below in the Examples, exposure to 12.4 GHz radiation killed all bed bugs at all stages of development even at short microwave exposure times of 15 s, which correlates well with the simulation results. As previously described, the resonance frequency is generally a function of dielectric properties and conductive properties of insects such as bed bugs.

### EXAMPLES

In the examples provided below, 300 W microwave generators (Instruments for Industry IFI-T82-300 2-8 GHz 300 W and IFI T188-300 8-18 GHZ 300 W) and capable of generating microwaves at 2-8 GHz and 8-18 GHz were used to test the eradication of bed bugs using microwave radiation. A sample including six bed bugs for each of the five bed bug life stages-adult female, adult male, small nymphs, medium sized nymphs, and large nymphs were placed in vials and in enclosures designed to match the output opening of a suitable wave guide. Based on the previously described modeling results, microwave radiation at 5.8 GHz, 9.2 GHz and 12.4 GHz were selected for testing. The bed bugs were fed within 72 hours of treatment. Table 1 shows the size of the bed bugs at the various life stages.

TABLE 1
Size of bed bugs at different life stages.

| Life Stage | Size (mm) |
|---|---|
| Eggs | 1 |
| 1^{st} stage nymph | 1.5 |
| 2^{nd} stage nymph | 2 |
| 3^{rd} stage nymph | 2.5 |
| 4^{th} stage nymph | 3 |
| 5^{th} stage nymph | 4.5 |
| Adult male bed bug | 5.8 |
| Adult female bed bug | 6.3 |

A signal generator was used to control the output of the system. A frequency specific waveguide was used and bed bugs were placed at or near the opening of the waveguide.

### Example 1. Exposure of Bed Bugs at Various Life Stages to Microwave Radiation at 200 W, 5.8 GHz and for 30 s

Upon exposure to radiation at 5.8 GHz for 30 s, all female bed bugs and some male bed bugs were killed. This radiation treatment had no effect on nymphs. In addition, no visible morphological changes in dead bugs were observed.

### Example 2. Exposure of Bed Bugs at Various Life Stages to Microwave Radiation at 150 W, 9.2 GHz and for 60 s

Upon exposure to radiation at 9.2 GHz for 60 s, all male and female bed bugs and all large nymphs were killed. About 80% of medium-sized nymphs were killed. This radiation treatment had no effect on small nymphs. In addition, no visible morphological changes in dead bugs were observed.

### Example 3. Exposure of Bed Bugs at Various Life Stages to Microwave Radiation at 200 W, 12.4 GHz and for 15 s and 30 s

Upon exposure to radiation at 12.4 GHz for exposure times (also referred to herein as treatment times) of 15 s and 30 s, all bed bugs at all life stages were killed. After treatment, bed bugs were scattered throughout the vials. Post treatment bed bugs had a larger and lighter colored appearance as if they had been “puffed up” or expanded like a balloon.

The example system and methods described herein are not necessarily limited in their application to eradicate or control bed bug infestation. They may be used to eradicate or control other insects that include one or more of bat bugs, swallow bugs, poultry bugs, ticks, termites, or rice weevils. As such, the scope of the invention is not limited to the bed bug control and eradication.

The Abstract is provided to comply with 37 C.F.R. § 1.72 (b), to allow the reader to determine quickly from a cursory inspection the nature and gist of the technical disclosure. It should not be used to interpret or limit the scope or meaning of the claims.

Although the present disclosure has been described in connection with the preferred form of practicing it, those of ordinary skill in the art will understand that many modifications can be made thereto without departing from the spirit of the present disclosure. Accordingly, it is not intended that the scope of the disclosure in any way be limited by the above description.

It should also be understood that a variety of changes may be made without departing from the essence of the disclosure. Such changes are also implicitly included in the description. They still fall within the scope of this disclosure. It should be understood that this disclosure is intended to yield a patent covering numerous aspects of the disclosure both independently and as an overall system and in both method and apparatus modes.

Further, each of the various elements of the disclosure and claims may also be achieved in a variety of manners. This disclosure should be understood to encompass each such variation, be it a variation of an implementation of any apparatus implementation, a method or process implementation, or even merely a variation of any element of these.

Particularly, it should be understood that the words for each element may be expressed by equivalent apparatus terms or method terms-even if only the function or result is the same. Such equivalent, broader, or even more generic terms should be considered to be encompassed in the description of each element or action. Such terms can be substituted where desired to make explicit the implicitly broad coverage to which this disclosure is entitled. It should be understood that all actions may be expressed as a means for taking that action or as an element which causes that action. Similarly, each physical element disclosed should be understood to encompass a disclosure of the action which that physical element facilitates.

In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Further, the use of the transitional phrase “comprising” is used to maintain the “open-end” claims herein, according to traditional claim interpretation. Thus, unless the context requires otherwise, it should be understood that variations such as “comprises” or “comprising,” are intended to imply the inclusion of a stated element or step or group of elements or steps, but not the exclusion of any other element or step or group of elements or steps. Such terms should be interpreted in their most expansive forms so as to afford the applicant the broadest coverage legally permissible.

### REFERENCES

1. W. S. Cranshaw, M. Camper, F. Pearis “Bat Bugs, Bed Bugs and Relatives,” Fact Sheet No. 5.574, Colorado State University, December 2013.
2. D. M. Miller, A. Polanco, “Bed Bug Biology and Behavior,” Virginia Polytechnic Institute and State University, August 2010.
3. S. O. Nelson, “Radio-Frequency and Microwave Dielectric Properties of Insects,” J. Microwave Power and Electromagnetic Energy, 36 (1), 2001.
4. J. Ondráček, and V. Brunnhofer, “Dielectric Properties of Insect Tissues,” Gen. Physiol. Biophys., 3, 251-57, 1984.
5. A. Thielens, D. Bell, D. B. Mortimore, M. K. Greco, L. Martens and W. Joseph, “Exposure of Insects to Radio-Frequency Electromagnetic Fields from 2 to 120 GHz,” Scientific Reports (Nature), 2018) 8:3924.
6. A. Tyrpak, “How to Kill Bed Bugs in Portable Items: Unconventional Non-chemical Approaches,” Senior Research Thesis, The Ohio State University, May 2016.

1. An insect eradication system for treating an insect-infested object while minimally heating the object, the system including:
a collapsible canopy frame configured to be disposed over an insect-infested object;
one or more RF shielding curtains supportable by the canopy frame and configured to envelop the insect-infested object;
one or more microwave horn antennas supported by a plurality of roof support members on the canopy frame, wherein the one or more horn antennas are disposed at a predetermined distance above the insect-infested object;
a portable cart movably disposed outside the RF shielding envelop and including a microwave generator configured to transmit microwave radiation from the microwave generator to the one or more microwave horn antennas; and
a control system configured to implement one or more of:
operate the microwave generator to generate microwave radiation at a frequency that is within ±250 MHz of a resonance frequency of an insect; or
direct the microwave radiation towards the insect-infested object, wherein the insect in the insect-infested object is killed by localized flash heating within its carapace as it oscillates at its respective resonance frequency when hit by microwave radiation.

2. The insect eradication system of claim 1, wherein the one or more RF shielding curtains includes a first curtain configured to envelop the insect-infested object and a second curtain disposed external to the first curtain.

3. The insect eradication system of claim 1, wherein the one or more microwave horn antennas each includes a flared end, wherein a predetermined distance between the insect-infested object and the flared end of the respective horn antennas is about 2 ft.

4. The insect eradication system of claim 1, wherein the one or more microwave horn antennas include pyramidal horn antennas.

5. The insect eradication system of claim 1, wherein the one or more microwave horn antennas are each configured to be connected to a respective swivel coupling supported by the plurality of roof support members.

6. The insect eradication system of claim 1, wherein the portable cart includes a plurality of internal compartments, wherein at least one of the internal compartments is configured to store one or more of the one or more microwave horn antennas or the one or more RF shielding curtains.

7. The insect eradication system of claim 1, wherein the control system is further configured to communicate with an application software associated with a smart device to remotely operate the insect eradication system or move the portable cart.

8. The insect eradication system of claim 1, wherein the portable cart includes a rechargeable battery power system.

9. A method for selectively eradicating insects in an insect-infested object using microwave radiation while minimally heating the object, the method including:
providing a decontamination system to envelop the insect-infested object, wherein the decontamination system includes:
one or more RF shielding curtains configured to envelop the insect-infested object, wherein the one or more RF shielding curtains is supportable by a collapsible canopy frame; and
a portable cart including a microwave generator movably disposed outside the RF shielding curtains, wherein the decontamination system is configured to transmit
microwave radiation from the microwave generator toward the insect-infested object;
selecting a first incident microwave radiation frequency that is within +250 MHz of a resonance frequency of an insect; and
exposing the insect-infested object to microwave radiation for a first predetermined treatment time, wherein the insect in the insect-infested object is killed by localized flash heating within its carapace as it oscillates at its resonance frequency when hit by microwave radiation.

10. The method of claim 9, wherein the first incident microwave radiation frequency is between about 10 GHz and about 15 GHz.

11. The method of claim 9, wherein the resonance frequency of the insect is about 12.5 GHz.

12. The method of claim 9, wherein the first predetermined treatment time is between about 5 s and about 30 s.

13. The method of claim 9, further including examining the insect-infested object after the first predetermined treatment time and repeating the exposing operation if an insect eradication is less than about 99%.

14. The method of claim 13, wherein the repeating the exposing operation includes exposing the insect-infested object to microwave radiation at a second incident radiation frequency that is greater than the first incident radiation frequency.

15. The method of claim 14, wherein the repeating the exposing operation further includes exposing the insect-infested object to microwave radiation for a second predetermined treatment time that is greater than the first predetermined treatment time.

16. The method of claim 13, wherein the examining operation includes examining the insect-infested object using one or more of visual inspection or inspection using a thermal imaging camera.

17. An insect eradication system for treating an insect-infested object while minimally heating the object, the system including:
a collapsible canopy frame configured to be inflated to form an inflated canopy frame over an insect-infested object;
a prefabricated microwave shield (RF shield) configured to envelop the inflated canopy frame;
one or more microwave horn antennas supported by a plurality of roof support members disposed on the collapsible canopy frame, wherein the one or more microwave horn antennas are disposed at a predetermined distance above the insect-infested object;
a portable cart movably disposed outside the prefabricated microwave shield, wherein the portable cart includes:
an air pump to inflate the collapsible canopy frame; and
and a microwave generator configured to transmit microwave radiation from the microwave generator to the one or more microwave horn antennas; and
a control system configured to implement one or more of:
operate the microwave generator to generate microwave radiation at a frequency that is within ±250 MHz of a resonance frequency of an insect; or
direct the microwave radiation towards the insect-infested object, wherein the insect in the insect-infested object is killed by localized flash heating within its carapace as it oscillates at its respective resonance frequency when hit by microwave radiation.

18. The insect eradication system of claim 17, wherein the microwave radiation is characterized by a frequency of between about 10 GHz and about 15 GHz.

19. The insect eradication system of claim 17, wherein the microwave radiation is characterized by a frequency of about 12.5 GHz.

20. The insect eradication system of claim 17, wherein the one or more microwave horn antennas include pyramidal horn antennas.

21. The insect eradication system of claim 17, wherein the one or more microwave horn antennas are each configured to be connected to a respective swivel coupling supported by the plurality of roof support members.
